(19) United States
(12) Patent Application Publication
(10) Pub. No.: US 2004/0165014 A1
(43) Pub. Date: Aug. 26, 2004

(54) Application of homepage automatic pilot system

(76) Inventor: Michael M. Lai, Taipei (TW)

Correspondence Address: BACON & THOMAS, PLLC, 625 SLATERS LANE, FOURTH FLOOR, ALEXANDRIA, VA, 22314

(21) Appl. No.: 10/368,566

(22) Filed: Feb. 20, 2003

(51) Int. Cl. G09G 5/00

(52) U.S. Cl. 345/866

(57) ABSTRACT

The present invention relates to an application of homepage automatic pilot system wherein one single representative URL automatically assigns suitable homepage information for browsers. The present invention of a homepage automatic pilot system provides a most suitable browsing and service model to the public wherein information origin is automatically determined for precise homepage pilot as regard to the complicated internet tools and browsing interfaces used nowadays.

### TECHNICAL RANGE

The present invention relates to an application of homepage automatic pilot system wherein one single representative URL automatically assigns suitable homepage browsers homepage contents.

### INVENTION BACKGROUND

Wireless channels of the Internet generation are being continuously expanded in application methods and skill such that more and more devices are being developed resulting in better communication between people and information. One can get access to Internet by using different device or equipment such as PC, Set-Top Box, PDA, PALM, WAP, 3G service and Information Appliances. However, it is quite inconvenient to use different browsing specifications and the same service application or web site needs to have its own browsing homepage each designed with different URL (Uniform Resource Locator). For example, if the Japanese firm “PROMISE” intends to provide browsing homepage to different users, four different homepages need to be prepared as well as the clients' different URL as below:

PC: http://cyber.promise.cojp/index

i-Mode http://cyber.promise.cojp/index.asp?710

J-Phone: http://cyber.promise.cojp/index.asp?712

KDDI: http://cyber.promise.cojp/index.asp?711

### SUMMARY

It is an object of the present invention of an application of homepage automatic pilot system to provide a most suitable browsing and service model to the public wherein information origin is automatically determined for precise homepage pilot as regard to the complicated tools and browsing interfaces used nowadays.

It is another object of the present invention of an application of homepage automatic pilot system wherein a single representative URL is provided by concerning firms and automatically determines different information origin which is further assigned automatically to suitable browsers homepage contents.

It is yet another object of the present invention of an application of homepage automatic pilot system to provide an independent system or match with TDNS (Telephone Domain Name System). Firms can keep their own Internet name by simply applying for such service and can immediately penetrate said new skill to register automatically and receive precise guiding of URL without any further information skill.

### MODE FOR CARRYING OUT INVENTION

With reference to FIG. 1 showing a plan of the commonly used invention in use, when the Information Provider (IP) sends information to the User, he makes use of different precise homepage for different browsers going through different URL. This is a disadvantage for both the IP and the user as the IP has to be first aware of the User's URL before sending any information.

With reference to FIG. 2 showing a plan of the present invention in use, the IP has only to use one single representative URL and apply for service application of said new skill of automatic pilot system for different guiding of homepage according to different requests as below:

i-Mode uses homepage www.i4uuu.com/i

KDDI uses homepage www.i4uuu.com/k

J-Phone uses homepage www.i4uuu.com/j

and other kinds of devices such as PDA, IA, Set-Top Box and so on.

Hence, regardless of devices used such as personal computer, i-Mode, KDDI, J-Phone and so on, the user has only to enter www.i4uuu.com/to automatically have access to the most suitable homepage content. This system is also an important application service skill for Mobile Internet.

### DESCRIPTION OF DRAWINGS

FIG. 1 shows a plan of the commonly used invention in use.

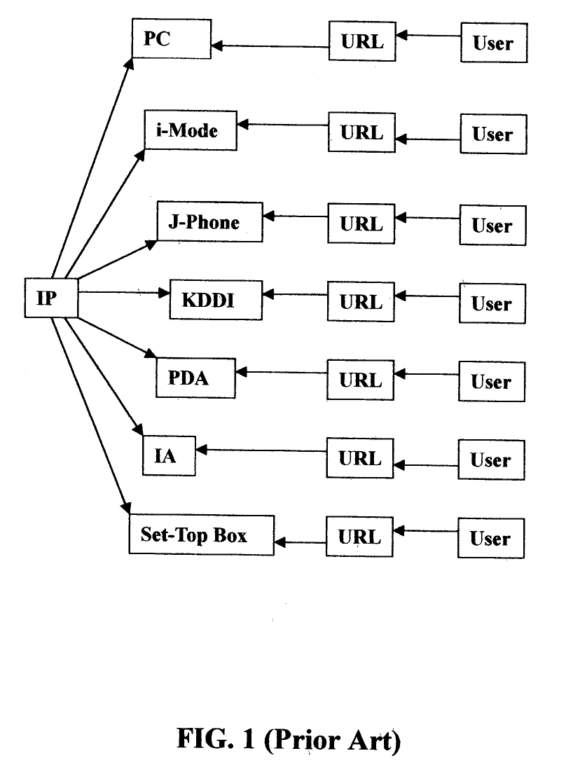

FIG. 2 shows a plan of the present invention in use.

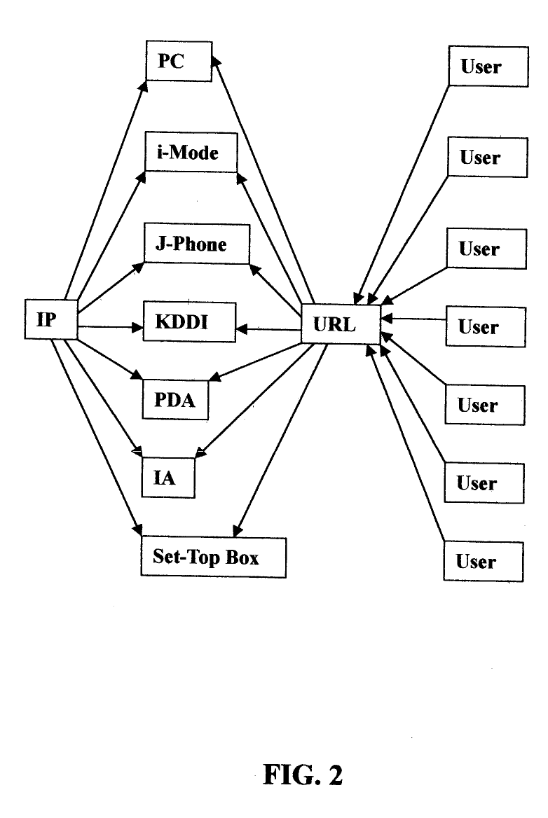

1. A kind of “Application of homepage automatic pilot system” providing the most suitable browsing and service model to the public wherein information origin is automatically determined for precise homepage pilot as regard to the complicated internet tools and browsing interfaces used nowadays wherein:
The Information Provider (IP) has only to use one single representative URL and apply for service application of said new skill of automatic pilot system for different guiding of homepage according to different requests, as characterized.
